(19) United States
(12) Patent Application Publication
(10) Pub. No.: US 2019/0090680 A1
(43) Pub. Date: Mar. 28, 2019

(54) HAND-HELD PORTABLE BEVERAGE MAKER

(71) Applicant: AnyCafé Inc., Springfield, MA (US)

(72) Inventors: Christopher Urciuoli, Springfield, MA (US); Logan Carlson, Springfield, MA (US)

(21) Appl. No.: 16/072,687

(22) PCT Filed: Jan. 31, 2017
(86) PCT No.: PCT/US2017/015753

§ 371 Date: Jul. 25, 2018

Related U.S. Application Data
(60) Provisional application No. 62/290,683, filed on Feb. 3, 2016.

(51) Int. Cl. A47J 31/00; A47J 31/06; A47J 31/46; A47J 31/40

(52) U.S. Cl. CPC A47J 31/005; A47J 31/407; A47J 31/468; A47J 31/0642

(57) ABSTRACT

A hand held portable beverage maker is provided. The beverage maker having a shell with a first interior portion. A reservoir fits within the first interior portion and has a second interior portion with an opening extending through a bottom wall, the reservoir further having a first channel extending from a bottom surface to a top surface. A lid is coupled to the shell and a second channel is formed between the lid and a detachable second channel coupled on a first end to the first channel when the lid is in a close position. The second channel further having a second open end disposed centrally on the lid. A holder is configured to receive a beverage cartridge within the second interior portion and is fluidly coupled to receive a liquid the second open end. A heater and bubble pump are fluidly coupled between the opening and the second channel.

### BACKGROUND OF THE DISCLOSURE

The subject matter disclosed herein relates to a portable beverage maker for beverages, and in particular to a beverage maker that allows the user to brew a hot beverage in a container without external devices.

College students and young professionals are often confronted with the need or want for beverages on the go. When confronted with this situation most will turn to their conventional habits to get their hot beverage or simply go without.

Options to help the user with this problem include single serve brewing systems which have grown in popularity due to their convenience and speed. However, these brewing systems are expensive and are not portable causing it to be difficult to be made on the go. This results in the user needing to go to a coffee shop, to waste time at a coffee machine or go without. Coffee shops are slow and mistakes are made with orders to create an unsatisfying product for the user. Wasting time at a coffee machine is unproductive, inconvenient and lacking in quality. Going without the beverage is also unsatisfying and possibly harmful to productivity.

Accordingly, while brewing systems are useful for their intended purposes the need for improvement remains, particularly in providing a cost effective brewing system that is portable and integrates with the drinking container.

### BRIEF DESCRIPTION OF THE DISCLOSURE

According to one aspect of the disclosure, a hand held portable beverage maker is provided. The beverage maker including a shell having a first interior portion. A reservoir is sized to fit within the first interior portion, the reservoir having a second interior portion with an opening extending through a bottom wall, the reservoir further having a first channel extending through the upper portion of the reservoir. A lid is coupled to the shell, a secondary piece with a channel is connected to the lid and fluidly coupled on a first end to the first channel when the lid is in a close position, the second channel further having a second open end disposed centrally on the lid. A holder is configured to receive a beverage cartridge, the holder being sized to fit within the second interior portion, a top portion of the holder being fluidly coupled to receive a liquid and expel it out the second open end. A heater is disposed within the first interior portion and fluidly coupled to the opening. A bubble pump is fluidly coupled between the heater and the second channel.

According to another aspect of the disclosure a method of making a beverage in a hand-held portable beverage maker is provided. The method comprising: placing a predetermined amount of a liquid in a reservoir; placing a beverage cartridge in a holder and disposing the holder in the reservoir; flowing the liquid through an opening in the bottom of the reservoir into a heater; increasing the temperature of the liquid with the heater; flowing the liquid with a bubble pump through a channel in the reservoir to an end opposite the bubble pump; flowing the liquid into a beverage cartridge; and flowing the liquid from the beverage cartridge into the reservoir.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a front exploded view of a hand-held portable beverage maker, according to some embodiments of the invention;

FIG. 2 is a perspective exploded view of the beverage maker of FIG. 1;

FIG. 3 is a side exploded view of the beverage maker of FIG. 1;

FIG. 4 is a perspective view of the beverage maker of FIG. 1 with the lid in an open position;

FIGS. 5A-5D are various views of the beverage maker of FIG. 1 with the lid in a closed position;

FIG. 6A-6E are various views of a reservoir for use with the beverage maker of FIG. 1, according to some embodiments of the invention;

FIG. 7A-7C are views of a bubble pump, according to some embodiments of the invention;

FIG. 8A-8D are various views of a heater member for use with the beverage maker of FIG. 1, according to some embodiments of the invention;

FIG. 9A-9C are various views of a beverage cartridge holder for use with the beverage maker of FIG. 1, according to some embodiments of the invention;

FIG. 10A-10E are various views of a lid for use with the beverage maker of FIG. 1, according to some embodiments of the invention;

FIG. 11A-11E are various views of the interior lid channel for use with the beverage maker of FIG. 1, according to some embodiments of the invention;

FIG. 12A-12E are various views of the Latch for use with the beverage maker of FIG. 1, according to some embodiments of the invention;

FIG. 13A-13D are various views of the lid stopper for use with the beverage maker of FIG. 1, according to some embodiments of the invention;

FIG. 14A-14D are various views of a shell for use with the beverage maker of FIG. 1, according to some embodiments of the invention;

FIG. 15A-15D are various views of a bottom plate for use with the beverage maker of FIG. 1, according to some embodiments of the invention; and

FIG. 16A-16F are various views of the battery pack casing for use with the beverage maker of FIG. 1, according to some embodiments of the invention;

FIG. 17A-17D are various views of the battery pack bottom plate for use with the beverage maker of FIG. 1, according to some embodiments of the invention;

FIG. 18A-18D are various views of the battery pack latch for use with the beverage maker of FIG. 1, according to some embodiments of the invention;

FIG. 19A-19D are various views of an actuator button for use with the beverage maker of FIG. 1, according to some embodiments of the invention.

The detailed description explains embodiments of the disclosure, together with advantages and features, by way of example with reference to the drawings.

### DETAILED DESCRIPTION OF THE DISCLOSURE

In order to solve this issue as described above, embodiments herein provide for a hand held portable beverage maker which can be brought with the user anywhere. Embodiments provided herein are reasonable in size, weight to allow it to be carried and handled by a single person. Embodiments provided here are also affordable for an average household.

Embodiments of the hand held portable beverage maker described herein are easy to use, portable, cost effective and compact. The beverage maker is small and light enough to be carried anywhere by a single user or in some type of carrying device. Embodiments provided herein provide advantages in allowing easy and effective brewing of beverage cartridges on the go thereby saving the user time, money and energy without inconveniencing the user.

As used herein a beverage cartridge means a prepackaged container that contains a material, such as but not limited to coffee, cocoa or tea for example, to be used in the brewing process. As described in more detail herein, the beverage cartridge may be made from one or more materials that are intended to be punctured as part of the brewing process to allow a fluid (e.g. water) to enter and exit the container. A commercially available beverage container is the K-Cup® pod manufactured by KEURIG GREEN MOUNTAIN, Inc.

Referring now to the attached drawings, the component descriptions corresponding to the component numbers are listed below, all of the listed components can be made from any material such as plastics, metals, wood, etc. and not all parts have to be made from the same materials.

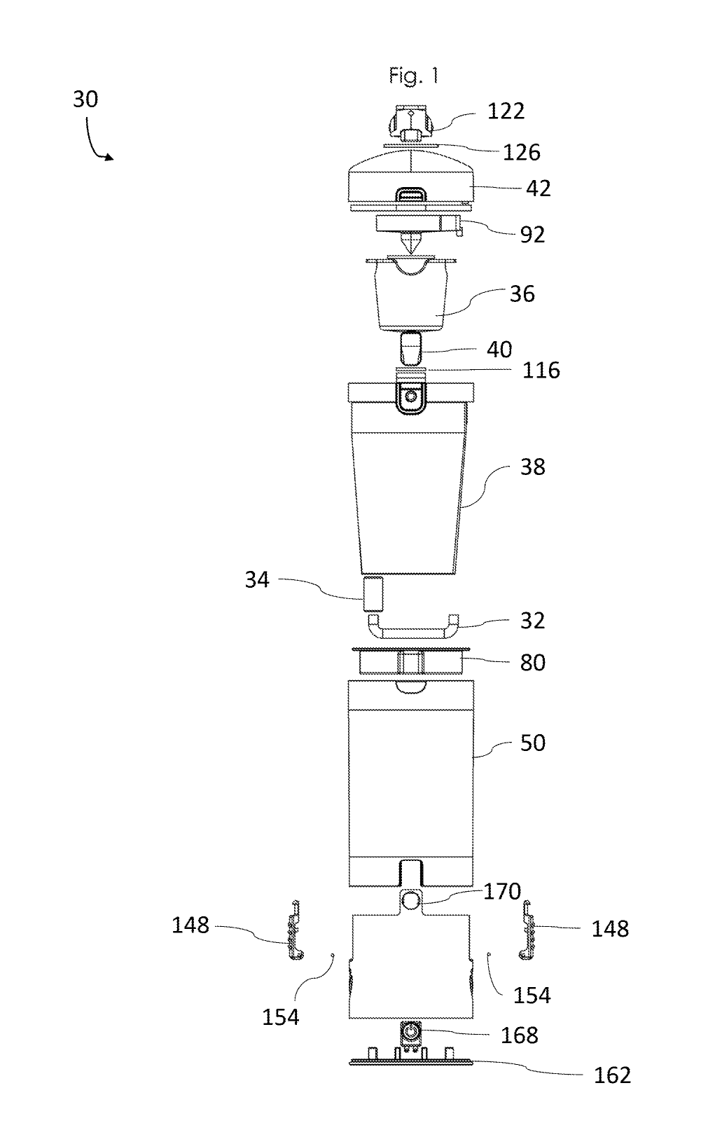

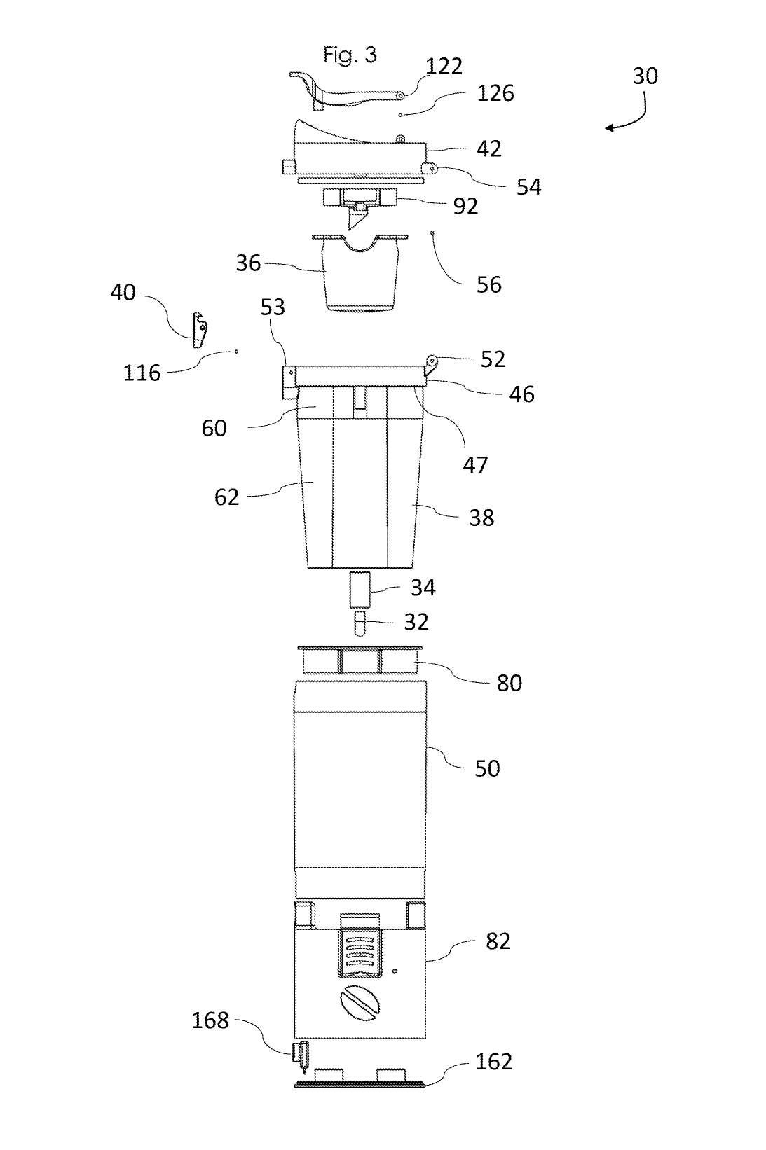

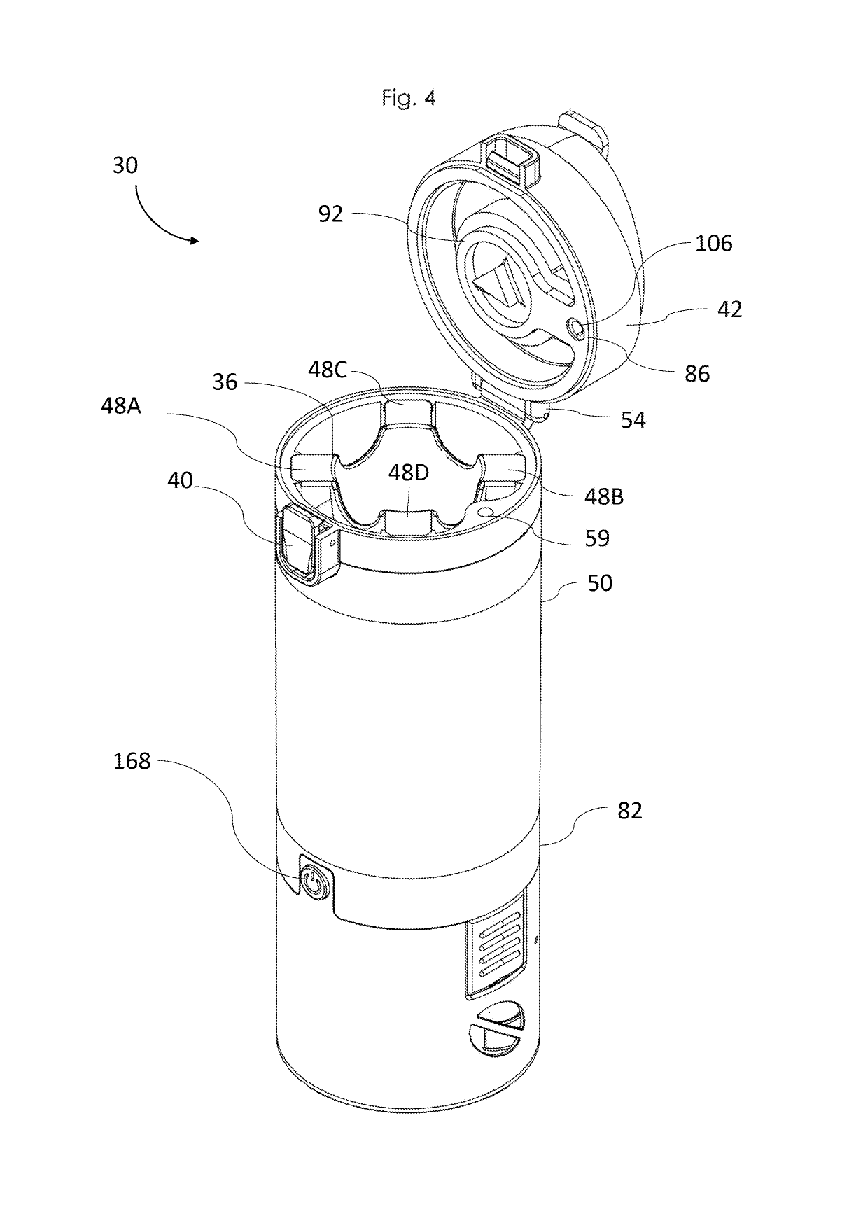

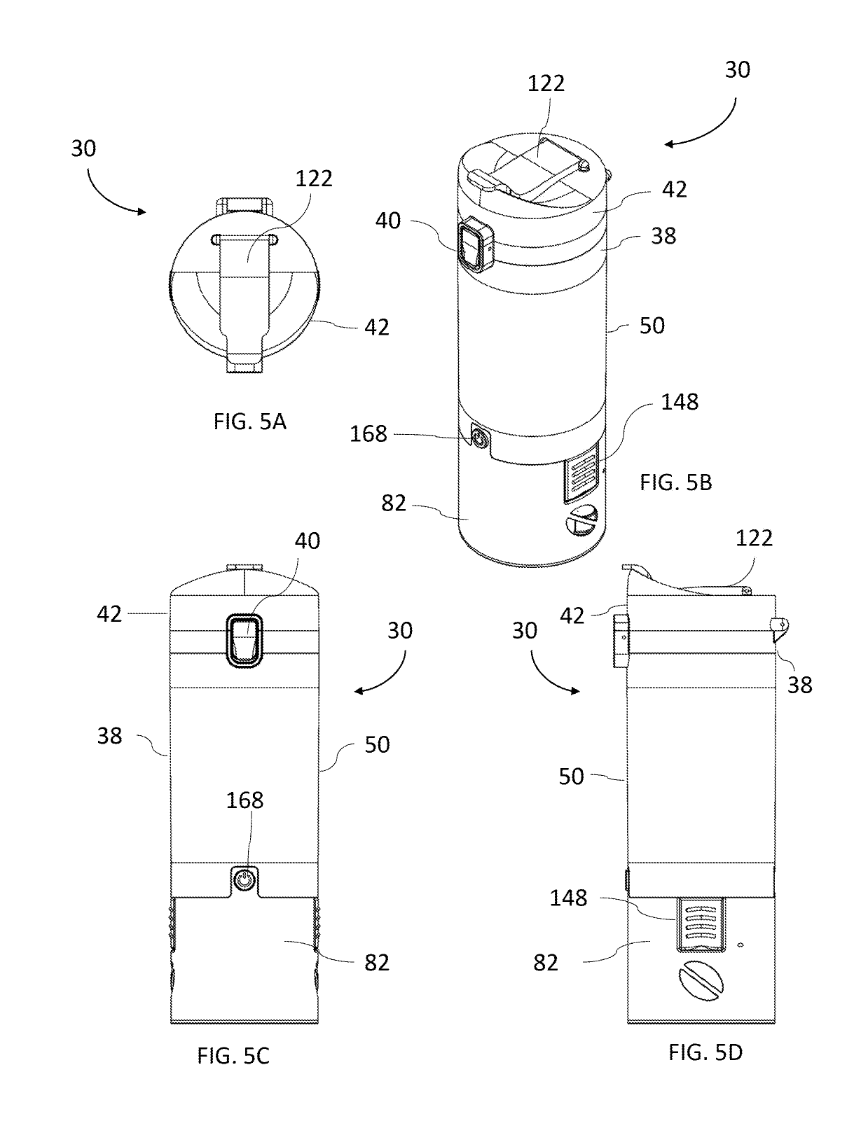

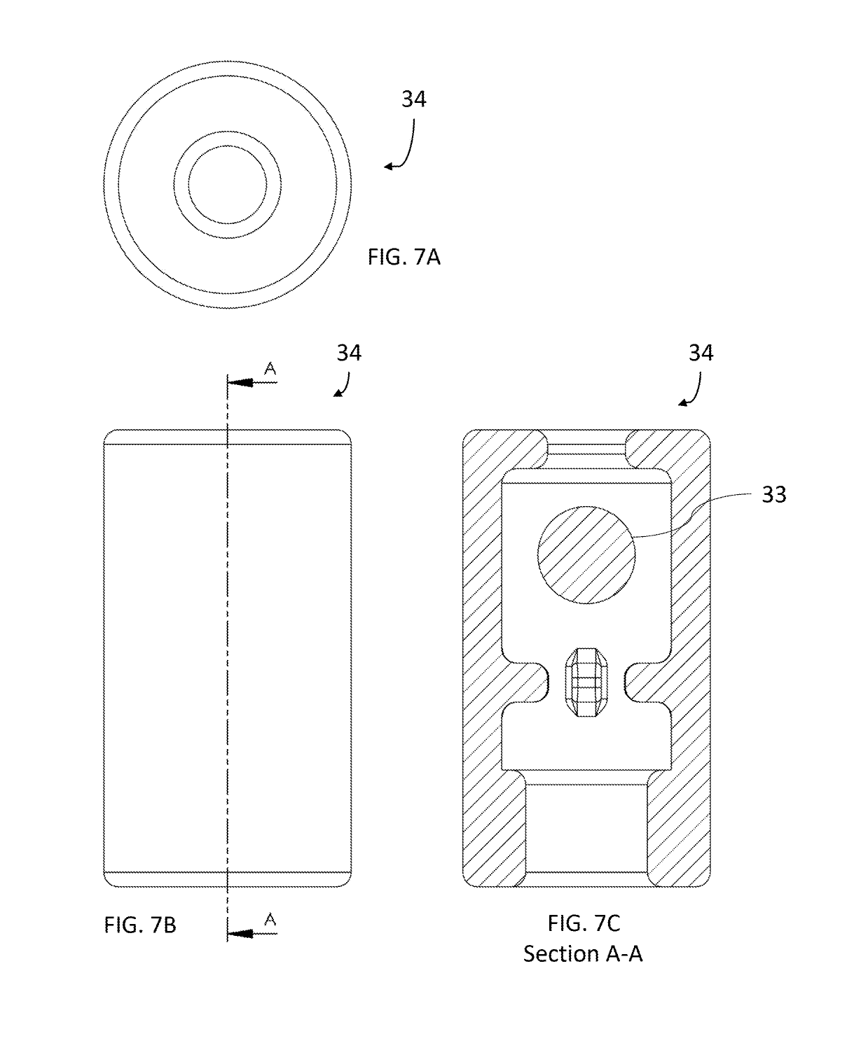

Referring now to FIGS. 1-5D, a hand held portable beverage maker 30 is provided. This hand held portable beverage maker 30 is powered using an electrical source or battery within. This power is used to warm the heater 32 which creates a fluid flow within the beverage maker 30. Through this temperature differential in the beverage maker 30, a bubble pump stopper ball 33 (FIG. 7C) within a bubble pump 34 will continue to restrict flow in one direction while allowing full flow in another. This flow is then cycled through a beverage cartridge (not shown) located in a cartridge holder 36 to brew the beverage. The now brewed beverage then flows back into a reservoir 38. Once the brew time is completed, power to the beverage maker 30 is removed. A lid stopper or latch 40 connected to a lid 42 can then be released and opened (FIG. 4) and the beverage can be consumed by the user without using a secondary container. it should be appreciated that by closing the lid 42 (FIG. 5A-5D), the user may carry the beverage without losing or spilling the fluid contained in the reservoir.

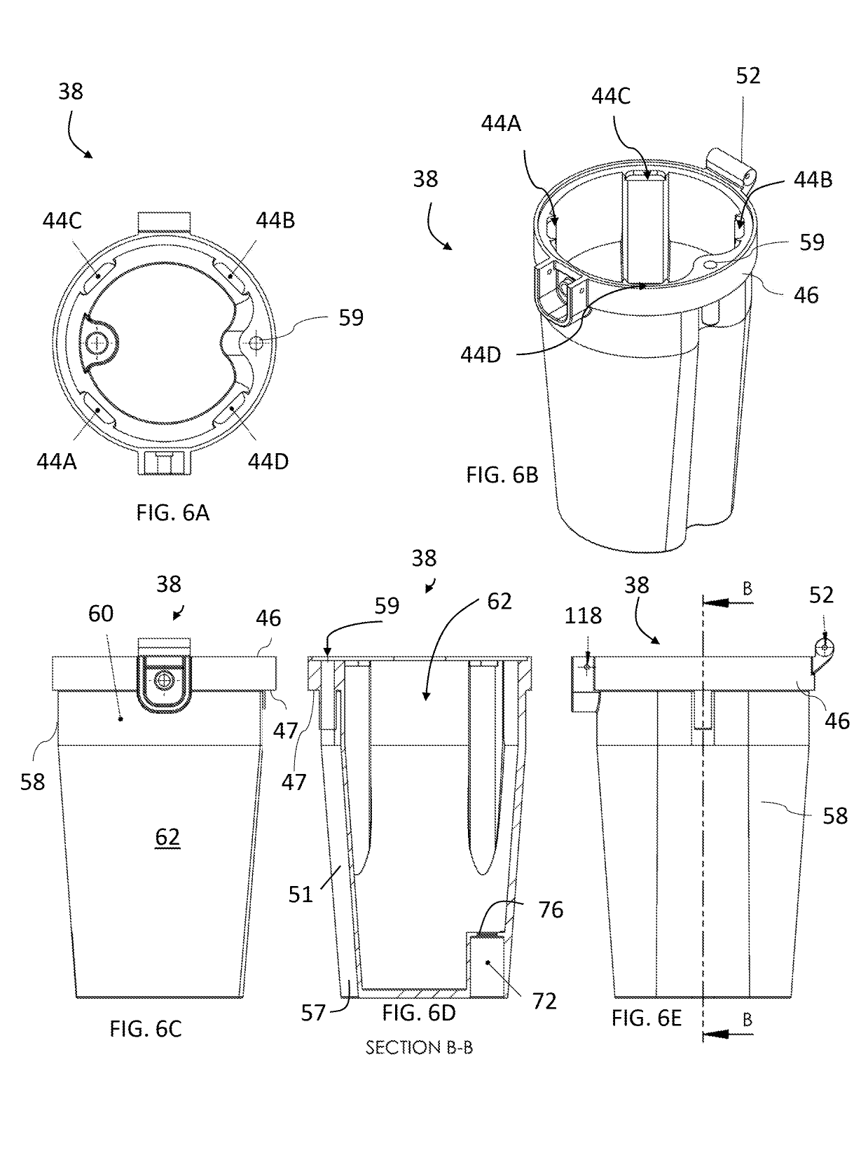

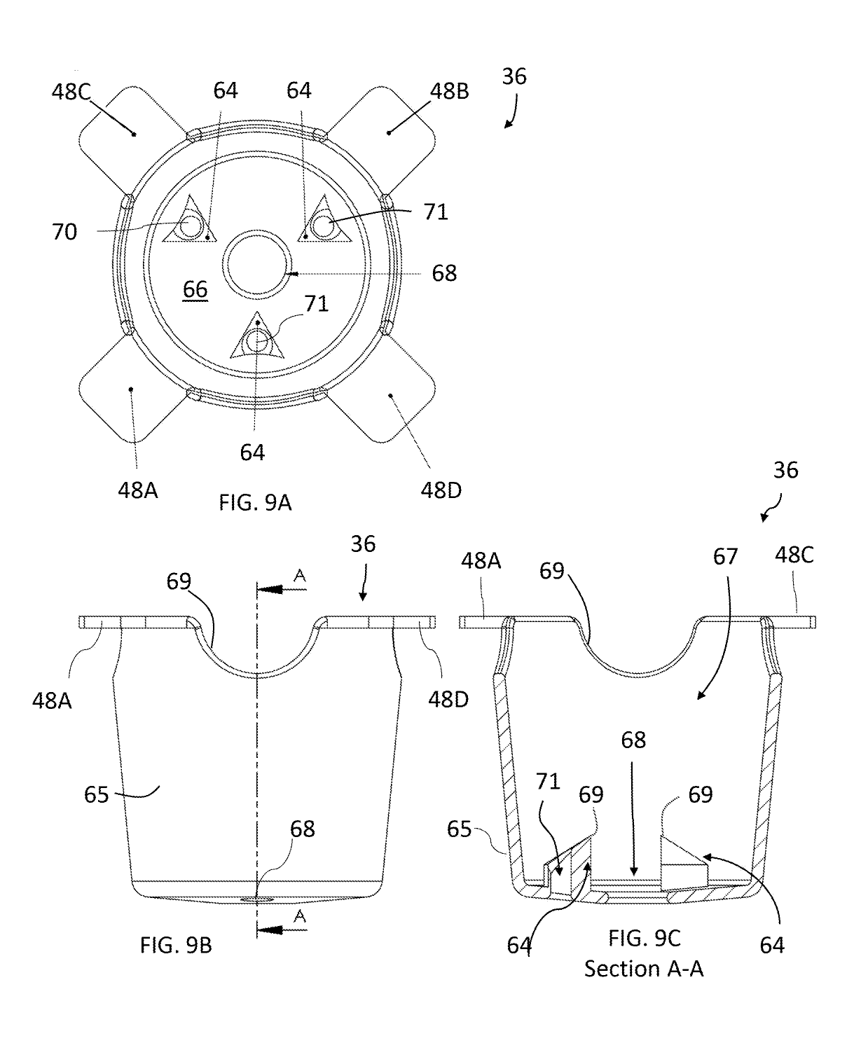

Referring now to FIGS. 6A-6E, an embodiment of the reservoir 38 is provided. The reservoir 38 has a semi-cylindrical top portion 46 that defines a lip 47. the lip 47 is sized to engage a top surface 49 of a shell 50. One side of the top portion 46 includes a hinge member 52 that cooperates with a hinge 54 of the lid 42, such as with a pin 56. Opposite the hinge member 52 is a latch projection 53 having a recess sized to receive the latch 40. In an embodiment, the latch 40 is coupled to the projection 53 by a pin 55 that allows the latch 40 to rotate. A body 58 extends from the top portion 46 that includes a semi-cylindrical portion 60 and a tapered portion 62. The top portion 46, and the body 48 define a hollow interior portion 62 that is sized to hold the liquid being brewed within the beverage maker 30. In an embodiment, the reservoir 38 also includes a plurality of indentations 44A, 44B, 44C, 44D in a top portion 46. These indentations 44A, 44B, 44C, 44D are aligned with tabs 48A, 48B, 48C, 48D respectively in the cartridge holder 36 (FIG. 9A-9C).

As will be discussed in more detail below, in an embodiment, the reservoir includes a channel 51 formed in the side wall of the body 58 and top portion 46. The channel 51 has a first end 57 arranged in the bottom surface and a second end 59 in the top surface. As will be discussed in more detail herein, the channel cooperates with the bubble pump 34 and heater 32 to move fluid from the reservoir 38 into the lid 42.

In still another embodiment, the body 58 further includes a recess 72 in the tapered portion 62. The recess includes an opening 76 that extends between the recess 72 and the hollow interior portion 62. As will be discussed in more detail herein, the opening 76 cooperates with the bubble pump 34 to move fluid from the reservoir 38 into the heater 32.

Referring now to FIG. 9A-9D with continuing reference to FIGS. 1-3, an embodiment of the cartridge holder 36 is shown having three projections 64 extending from a bottom surface 66. The cartridge holder 36 includes a body portion 65 that extends between the tabs 48A, 48B, 48C, 48D and the bottom surface 66. The body portion defines a hollow interior portion 67 that is sized to receive a beverage cartridge. In an embodiment, the body portion 65 includes semi-circular recesses or slots 69 that provide a space for the user's fingers to facilitate removing the beverage cartridge after the brewing is completed.

The projections 64 include an angled surface that terminates in a relatively sharp point 69 which allows for the puncture of the bottom of a beverage cartridge (not shown). In an embodiment, the projections 64 are equispaced 120 degrees apart. These projections 46 may also be disposed about an outlet 68 which allows for better flow of outlet water. It should be appreciated that in other embodiments, there may be any number of projections on the bottom surface 66 which allows for the puncture of the bottom of a beverage cartridge. In an embodiment, a hole 71 is positioned adjacent the projections 64. As will be discussed in more detail herein, the holes 71 is arranged to define a fluid path from the beverage cartridge and allow the brewed fluid to flow back into the hollow interior portion 62 of the reservoir 38.

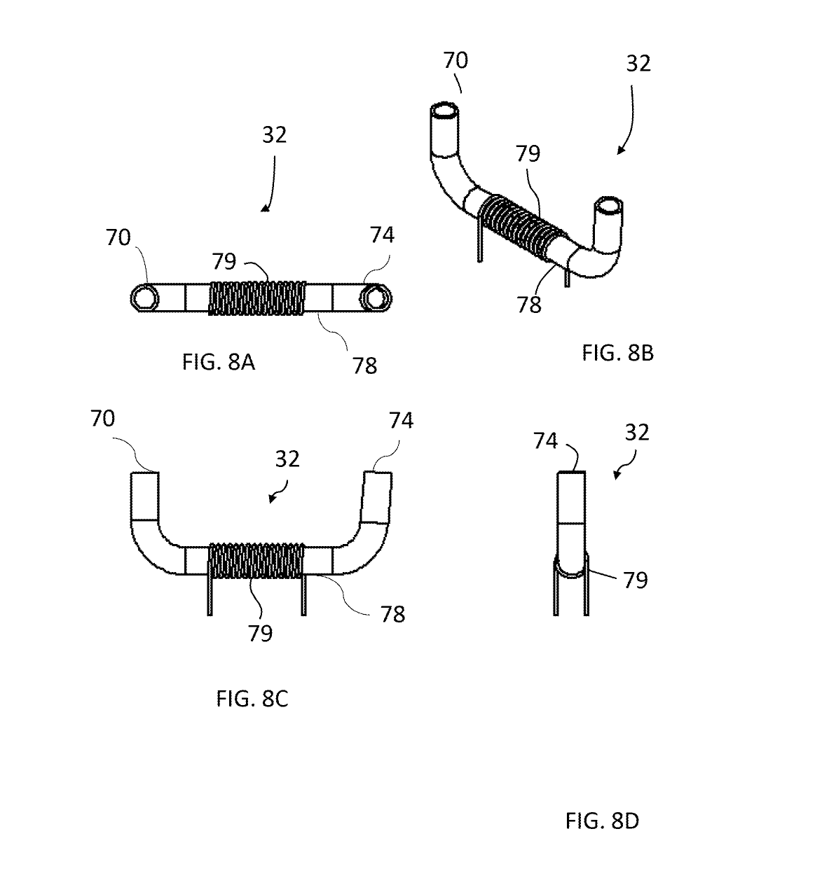

Referring now to FIGS. 8A-8D, with continuing reference to FIGS. 1-3, a heater member 32 is provided. The heater 32 is connected to the reservoir 38 by fluidly connecting port 70 to opening 57 (FIG. 6C) as well as inserting the bubble pump 34 into recess 72 and then fluidly connecting to port 74. This connection allows for a seal between the reservoir 38 and bubble pump 34 when fluid pressure is applied allowing for the flow of water only into port 74 and not through opening 74 into the interior portion 62 of reservoir 38. Port 74 is fluidly connected to conduit 78 which may be heated via a heating element 79 electrically connected to bottom plate 80 which is electrically connected to the battery pack casing 82. In the exemplary embodiment, the battery pack casing 82 includes a timer circuit and a charging circuit. In another embodiment there is an input for external power. Port 70 is fluidly connected to port 74 via conduit 78.

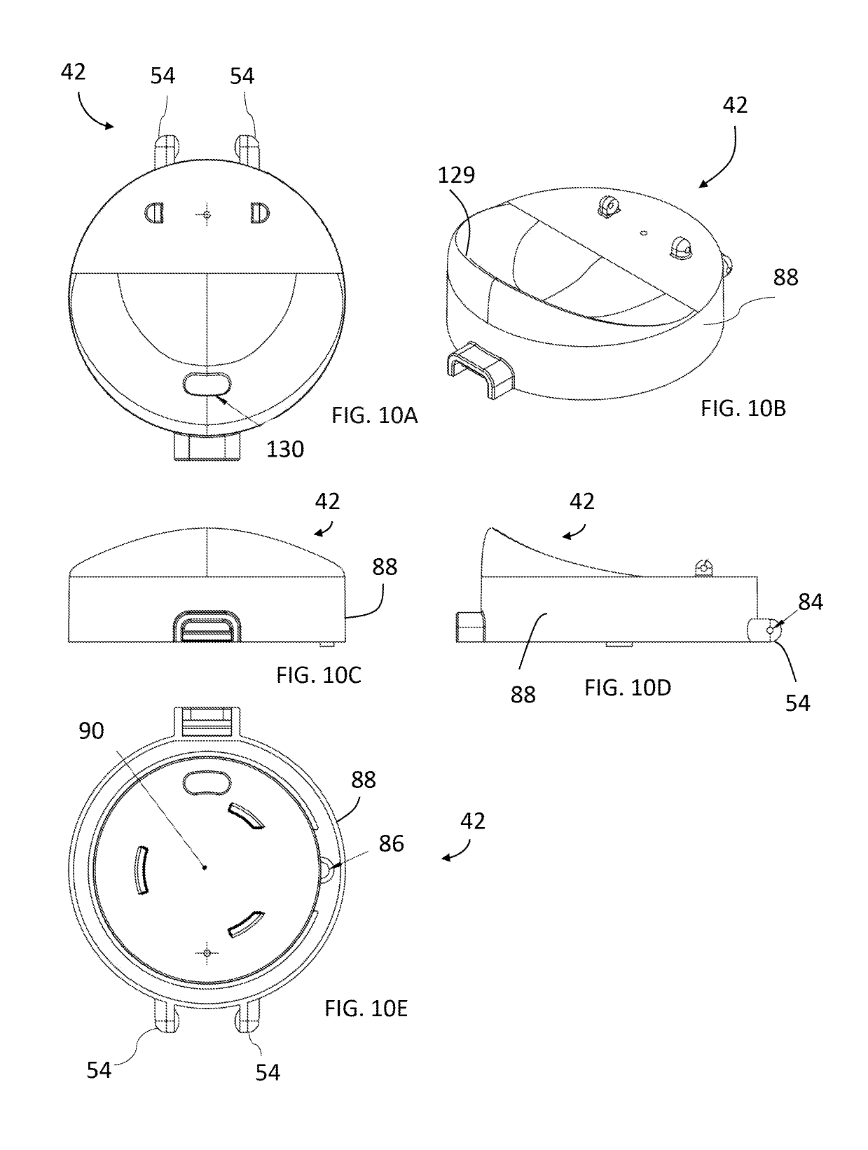

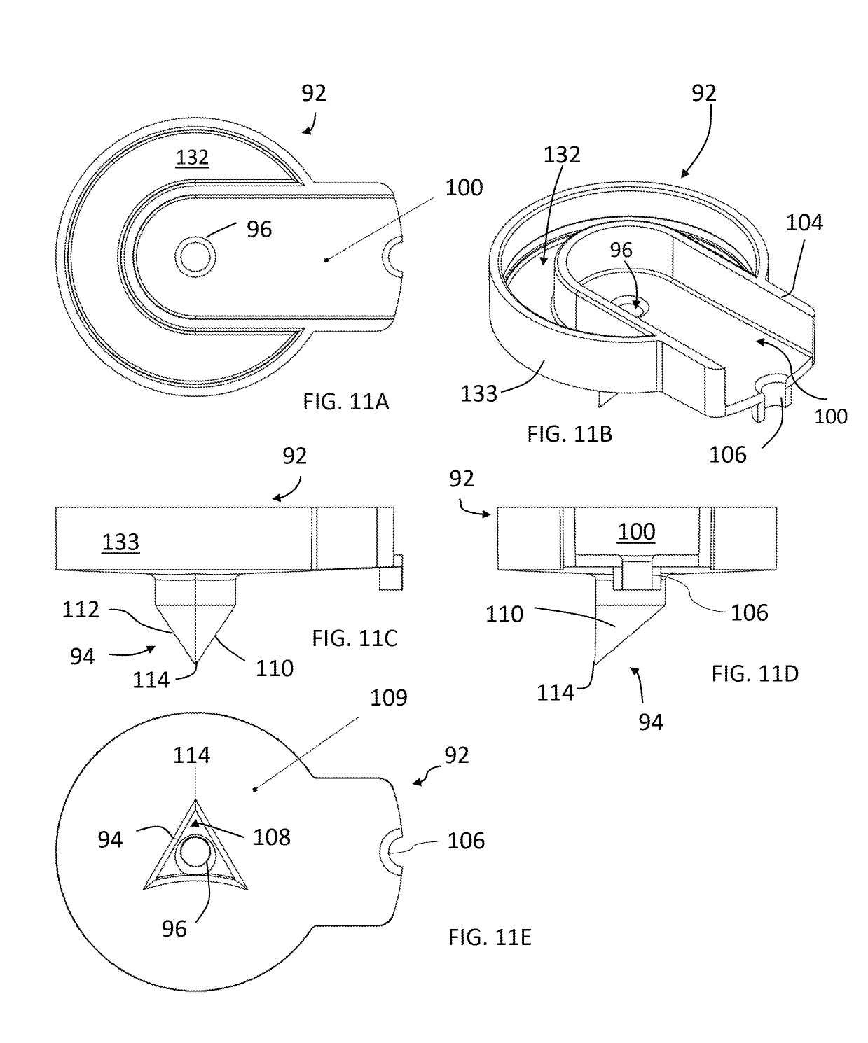

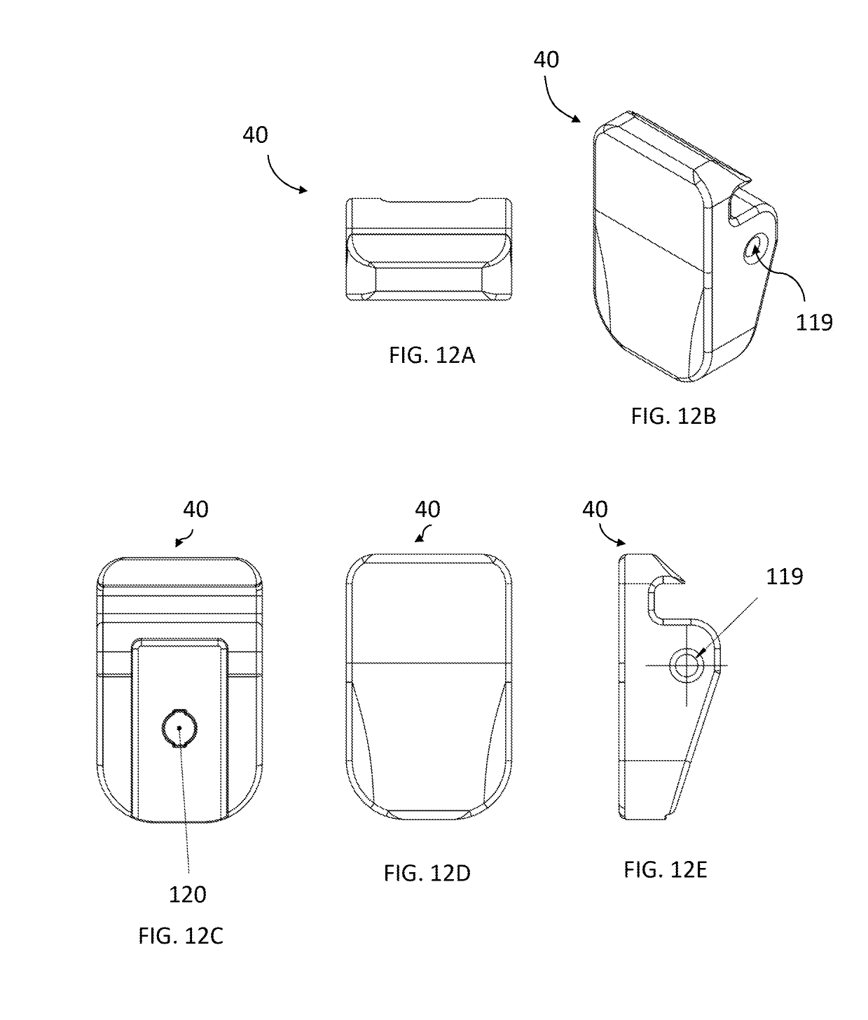

Referring now to FIG. 10A-10D and FIG. 11A-11E, with continuing reference to FIGS. 1-3, in an embodiment, the lid 42 is connected to the reservoir 38 by inserting a pin 56 through the concentric holes 84 in hinge 54. When the lid 42 is closed (FIG. 4) flat onto the reservoir 38 it is fluidly sealed. This creates a fluidly sealed channel from opening 59 (FIG. 6D) into port 86 formed in a sidewall 88 of the lid 42 then through a u-shaped channel 100 defined between the bottom surface 90 of the lid 42 and a detachable second channel member 92 then out an opening 96 in a puncture device 94 (FIG. 11C-11E). This puncture member 94 will puncture the top of the beverage cartridge upon the closing of the lid 42 when the beverage cartridge is loaded into the beverage cartridge holder 36. A rim 102 of the channel member 92 is fluidly sealed onto the top of the beverage cartridge when it is loaded into the beverage cartridge holder 36 and the lid 42 is closed.

In an embodiment, the channel 100 is further defined by a u-shaped wall 104 that extends from about the opening 96 to an inlet 106 that engages port 86. in an embodiment, the inlet 106 and the port 86 cooperate to define a fluid path from the opening 59 to the channel 100.

In an embodiment, the puncture member 94 is defines by three angled surfaces 110, 112 that converge at a sharp point 114. The surfaces 110, 112 define a hollow area 108 that is fluidly coupled to the opening 96. In operation, the point 114 punctures the top of the beverage cartridge to allow water from the opening 96 to flow therein.

In an embodiment, the latch 40 is used to couple the reservoir 38 to the lid 42. The latch 40 rotates about a pin 116 disposed in the concentric holes 118 (FIG. 6E). In an embodiment, a biasing member such as a spring (not shown) is arranged concentric with post 120 prior to the attachment of the latch 40. In another embodiment, a rubber material could be inserted into a slot prior to the attachment of the latch 40. The latch 40 secures the lid 42 and reservoir 38 together to prevent inadvertent opening of the lid 42 during the brewing process.

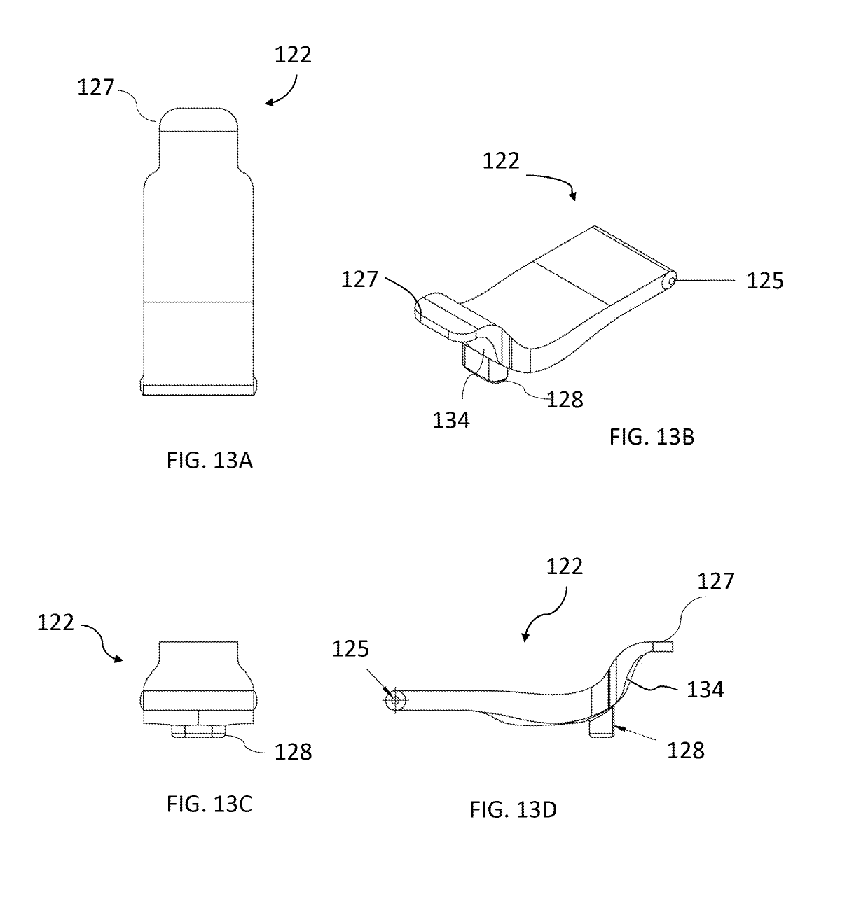

Referring now to FIGS. 13A-13D, with continuing reference to FIGS. 1-3 and FIGS. 10A-10E, an embodiment is shown of a lid stopper 122. The lid stopper 122 is connected at projection 124 by a pin 126 that is disposed through concentric holes 125. When in the open position, with a handle 127 is rotated away from surface 129 by the user, the stopper 128 is removed from drinking hole 130, leaving the drinking hole 130 open. The drinking hole 130 extends through the surface 90 to the open interior area 132 of channel member 92. The open interior area 132 being defined by a wall 133 The interior area 132 and drinking hole 130 define a fluid path that allows the user to drink the liquid in the reservoir 38. When in the closed position, the lid stopper 122 rotates back placing the stopper 128 into the drinking hole 130 creating a fluid seal that decreases the possibility of a leak from the drinking hole 130. In an embodiment, the lid stopper 122 includes a surface 134 that engages the surface 129 when in the closed position to secure the lid stopper 122.

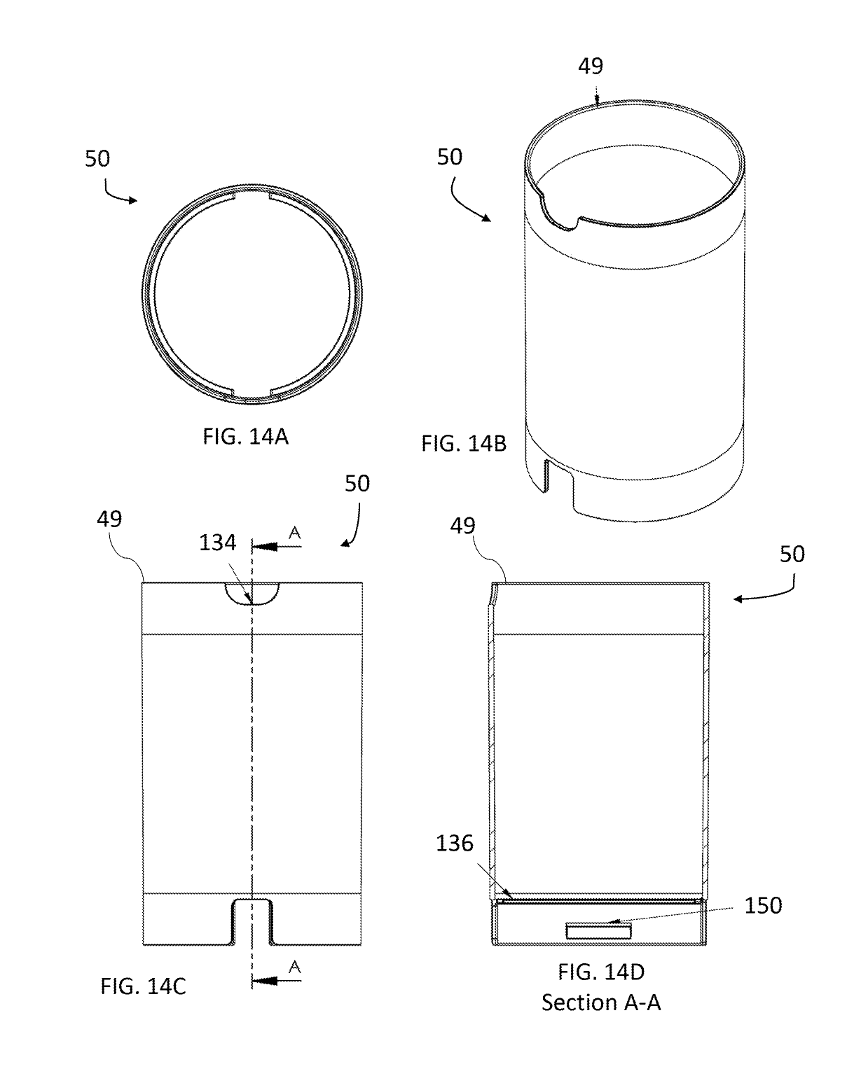

Referring now to FIG. 14A-14D, with continuing reference to FIGS. 1-3, an embodiment is shown of the shell 50. The shell 50 is connected to and disposed at least partially about the reservoir 38. The shell 50 is a generally hollow cylindrical body that is arranged concentrically with the body 58 with the edge 134 being aligned with indentation 44B of the reservoir 38. In an embodiment, the faces are sealed of the shell 50 and reservoir 38 are coupled using an adhesive or a bonding agent. Similarly, the bottom plate 80 is connected to a lip 136 with an adhesive or a bonding agent. In one embodiment a power source as well as the timer circuit and thermal gauge are attached to the bottom plate 80 on the face 138.

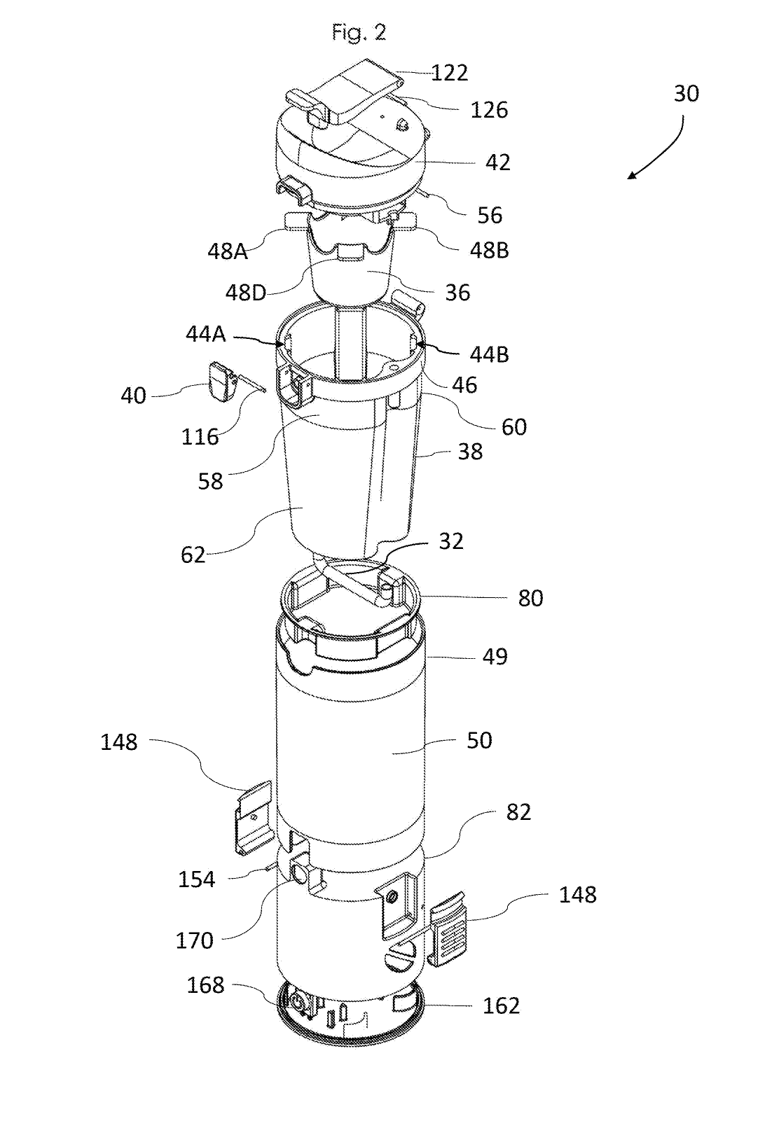

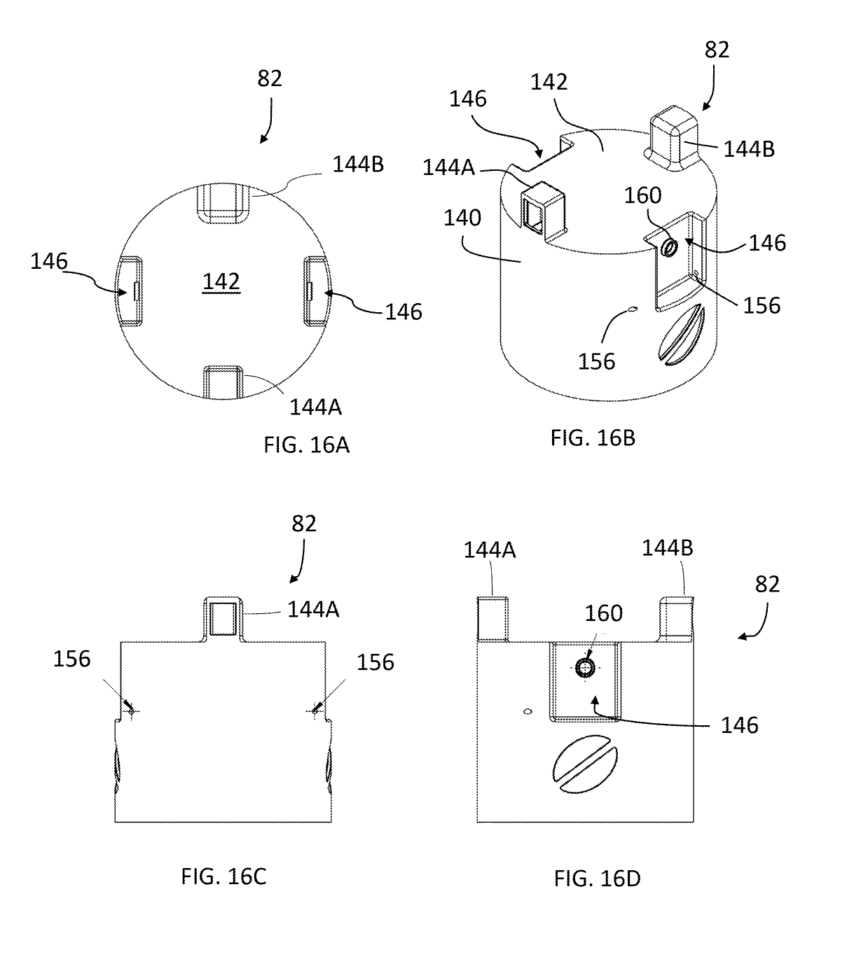

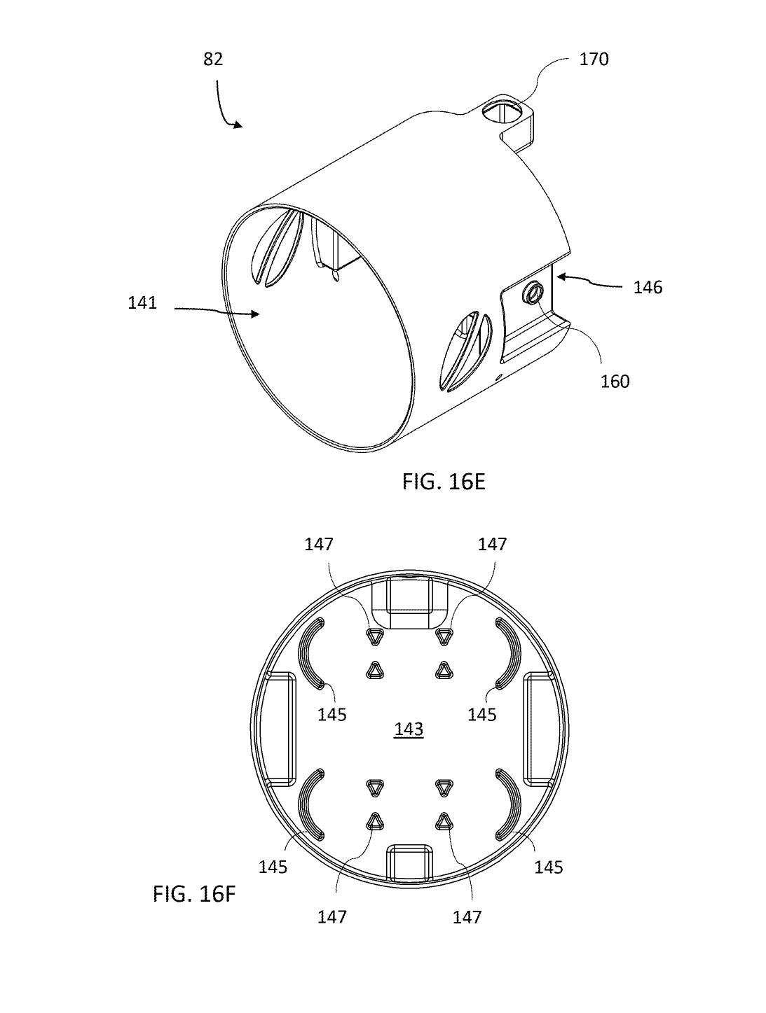

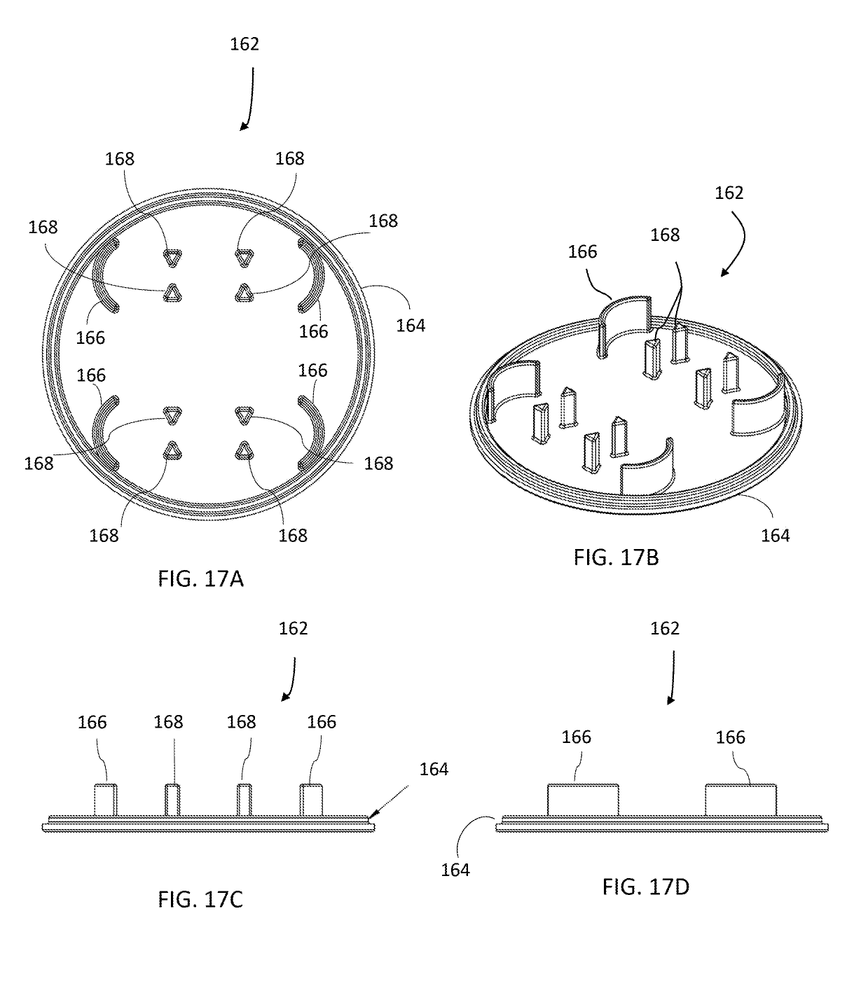

Referring now to FIG. 16A-16F, an embodiment is shown of the battery pack 82. The battery pack 82 includes a housing or casing 140 that is generally cylindrical in shape. The casing 140 includes a top surface 142 having a pair of opposing projections 144A, 144B extending therefrom. The casing 140 includes a pair of opposing slots 146 that are sized to receive the battery pack latch 148 (FIG. 2). In an embodiment, the slots 146 are oriented 90 degrees from the projections 144. The casing 140 has a hollow interior region 141 that is sized to receive a power source such as a battery and any charging or control circuits. In an embodiment, a surface 143 of the inner interior region 141 includes elements 145, 147 that are sized and positioned to engage batteries (not shown) and hold the batteries in place during use.

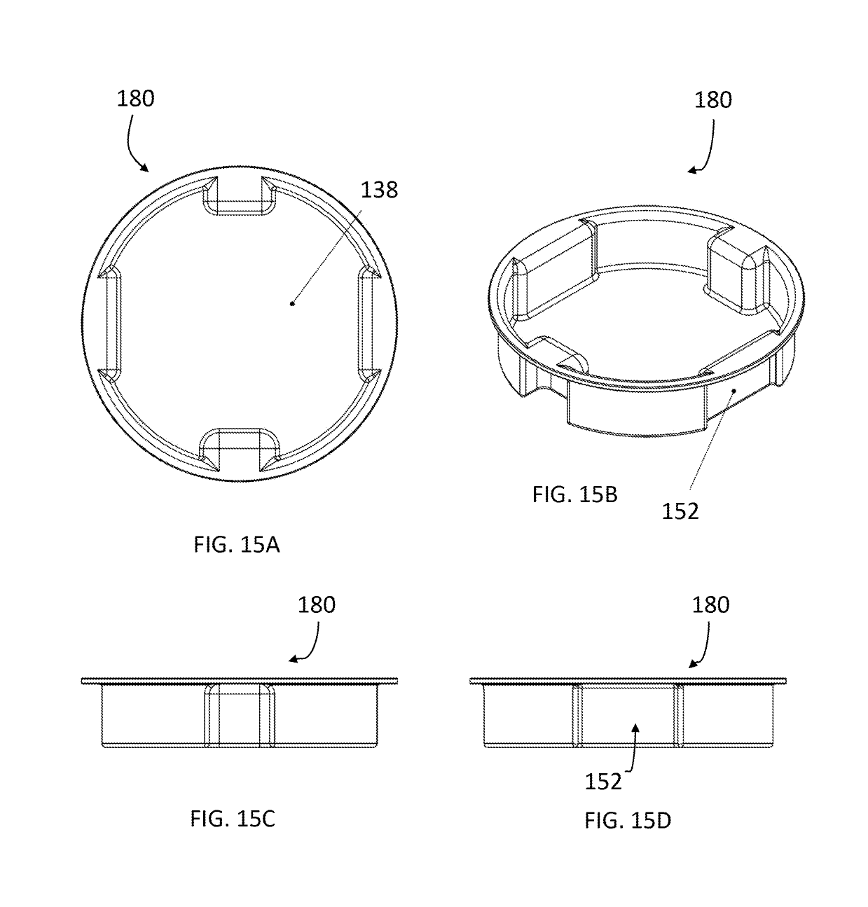

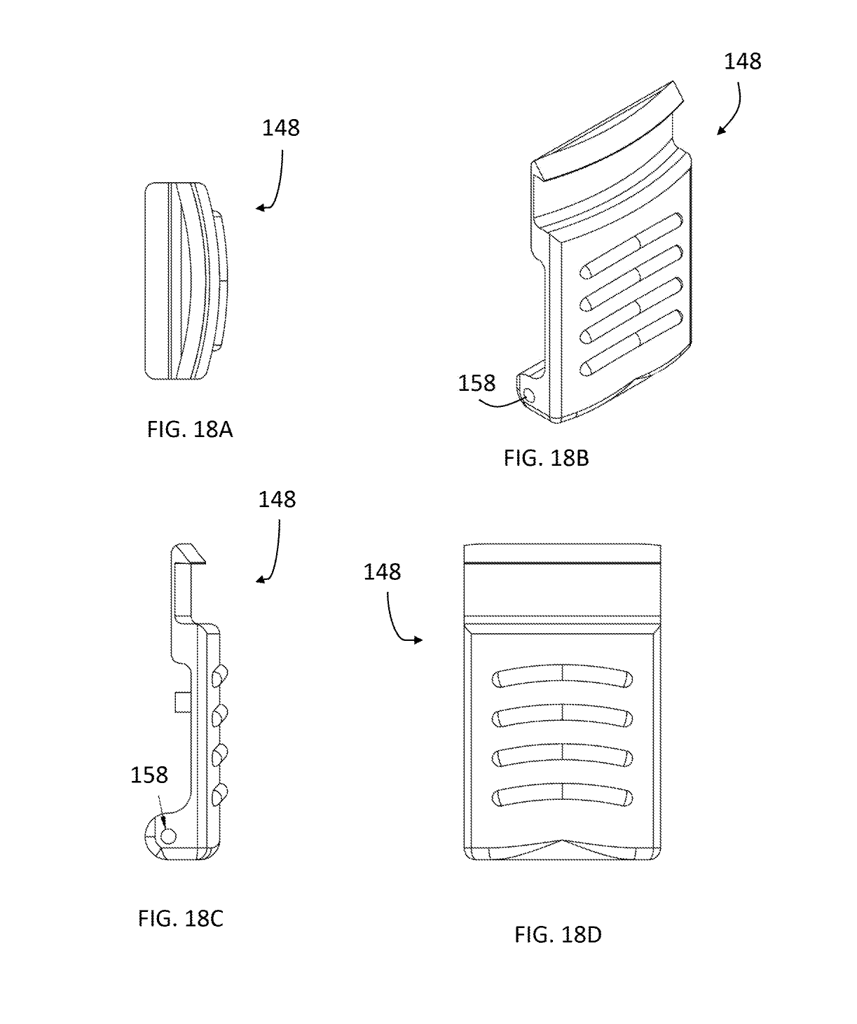

The casing 140 is concentrically arranged within the shell 50 and is coupled by aligning the battery pack latches 148 (FIG. 18A-18D) with the slots 150, 152 (FIG. 14D, FIG. 15B)) formed between the shell 50 and the bottom plate 80. Two battery pack latches 148 are attached to the casing 140 by aligning the battery pack latch 148 in the slots 146 and inserting a pin 154 through concentric holes 156 and 158. Additionally, a spring (not shown) may be inserted into the slot 160 prior to the attachment of the battery pack latches 148. In another embodiment, a rubber material could be inserted into slot 160 prior to the attachment of the battery pack latches 148. The battery pack bottom plate 162 is connected to the casing 140 by concentrically aligning a rim 164 with an inner diameter of the casing 150 and using an adhesive or a bonding agent. In another embodiment, the bottom plate 162 is coupled to the casing 140 using a mechanical fastener, such as screws or a snap fit. In still another embodiment, the bottom plate 162 is removable from the casing 140 to allow for the interchanging of batteries. The battery pack 82 contains a source of power in addition to circuits which provide the ability to charge and discharge the power source. The battery pack 82 also contains circuits which limit the incoming and outgoing current from and to the battery pack 82, prevent overcharging, overdraw and short circuiting of the power source. In one embodiment the battery pack 82 allows for the channeling of an external power source (not shown) directly to the heater 32.

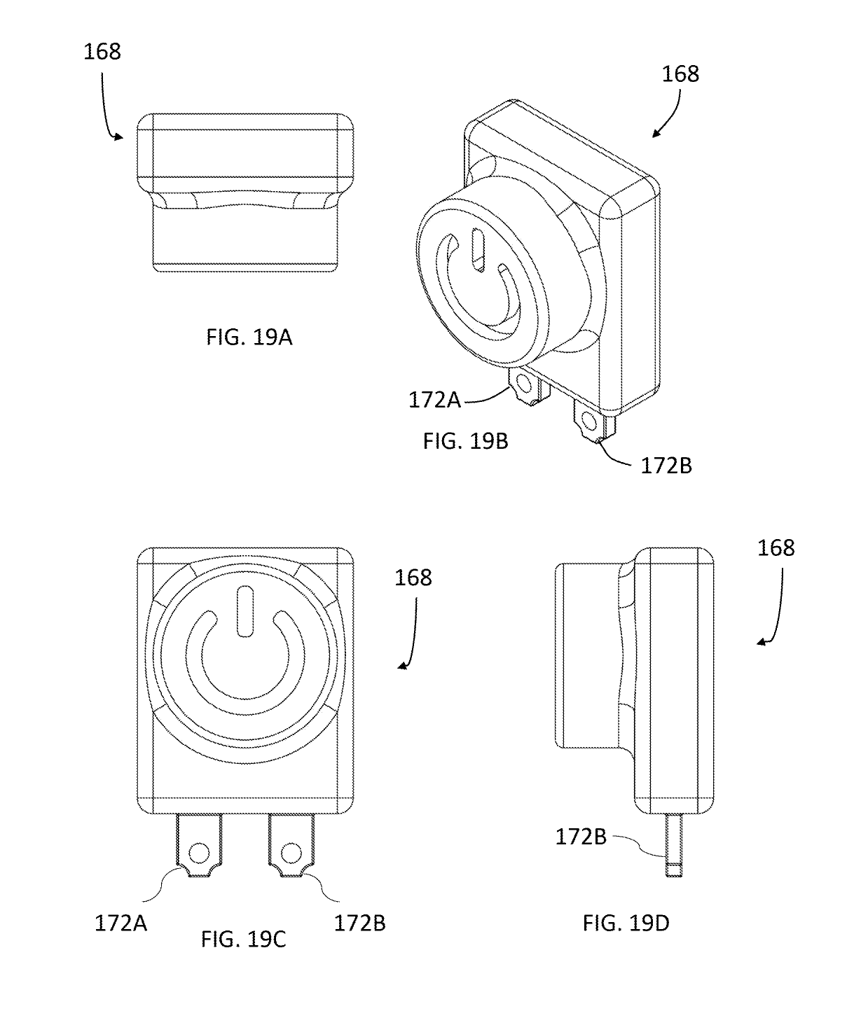

As shown in FIGS. 18A-18D, the bottom plate 162 includes elements 166 that are sized and shaped to receive a cylindrical body of a battery. In the exemplary embodiment, the beverage maker 30 includes four batteries, such as a 18650 size battery, which outputs 3.7 V. Three batteries are in series to create two “packs” and then these “packs” are wired in parallel. In an embodiment, the beverage maker 30 may further include an actuator button 168 shown in FIG. 19A-19D, that is positioned in an opening 170 (FIG. 2) of projection 144B. The actuator 168 includes a pair of terminals 172A, 172B. When the actuator 168 is depressed by the user, a circuit is completed that provides electrical power from the battery pack 82 to the heater 32.

During operation, liquid of a variable temperature from the hollow interior 62 of reservoir 38 to the cartridge holder 36 begins by filling the hollow interior 62 with the user desired liquid (e.g. water, milk or almond milk) and inserting the desired beverage cartridge into the cartridge holder 36. This liquid then travels through hole 76 into the recess 72 flowing around the bubble pump 34 filling the fluidly connected channel 78. This channel 78 is then heated upon the pressing of a button within the actuator 168 on battery pack 82 which completes the electrical connection between the heating element and power source within the battery pack. In an embodiment, the actuation of the actuator 168 also initiate's operation of a timer circuit and thermal gauge. The heating of the fluid in the channel 78 creates a thermal difference between the fluid in the channel 78 and that in the hollow interior 62. When the fluid attempts to flow back into the reservoir the bubble pump 34 partially fluidly seals the hole 176 forcing the fluid to flow into the fluidly connected port 70, then through another fluidly connected channel 51 and out the hole 59 which is concentric with, and fluidly connected to port 86. Upon entering port 86 the heated fluid enters the channel 100 formed between the bottom 90 of the lid 42 and the detachable channel member 92 then out the hole 96 of puncture member 94. The fluid then flows into a beverage cartridge positioned within the hollow interior region 67 of the cartridge holder 36. The fluid then proceeds to flow through the cartridge holder 36 and then out if a bottom puncture formed by the points 68 of projections 64. Once the fluid has been brewed in the beverage cartridge, it then proceeds to flow through the holes 71 and back into the hollow interior 62 of reservoir 38. In one embodiment, this process of flowing the fluid through the heater continues until the timer circuit reaches a set amount of time passing; in the exemplary embodiment the set number is equivalent to ten minutes of time passing. In another embodiment, the process continues until a thermal gauge (not shown) placed in close proximity to or within the reservoir reaches a desired predetermined temperature. In still another embodiment the process continues until the actuator 168 is pressed again. In still another embodiment, the process continues until a switch (not shown) placed on top of the reservoir becomes un-engaged.

Embodiments of the beverage maker provide advantages in allowing the user to make a hot beverage, such as but not limited to coffee and tea for example, at any location at any time. Embodiments of the beverage maker may further provide a hand held portable hot beverage maker is presented which can brew hot beverages via individual beverage cartridges. Embodiments of the beverage maker may further provide for continuously brewing of the beverage cartridges using a resistive heater and thermosiphon technology. Embodiments of the beverage maker provide for placing the beverage cartridge within the unit and puncturing the beverage cartridge when the lid is closed. This allows water to be drawn from the main reservoir by the thermosiphon and circulated through the resistive heater heating the liquid. The now heated liquid is then circulated to the point of puncture at the top of the beverage cartridge. The heated liquid passes through the beverage cartridge and back into the reservoir. In some embodiments, this process is performed continuously for a variable amount of time to brew the beverage as desired by the user or based on a predetermined time period. Embodiments of the beverage maker provide for a small self-contained method of brewing beverage cartridges.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. A hand held portable beverage maker comprising:
a shell having a first interior portion;
a reservoir sized to fit within the first interior portion, the reservoir having a second interior portion with at least one opening extending through a bottom wall, the reservoir further having a first channel extending from a bottom surface to a tope surface;
a lid coupled to the shell, the lid at least partially defining a second channel fluidly coupled on a first end to the first channel when the lid is in a close position, the second channel further having a second open end disposed centrally on the lid;
a holder configured to receive a beverage cartridge, the holder being sized to fit within the second interior portion, a top portion of the holder being fluidly coupled to receive a liquid the second open end;
a heater fluidly coupled to the opening and arranged to heat water from the reservoir; and
a bubble pump fluidly coupled between the heater and the second channel.

2. The beverage maker of claim 1, further comprising a channel member at least partially disposed within the lid, the channel member cooperating with the lid to define the second channel.

3. The beverage maker of claim 2, wherein the channel member includes a u-shaped channel that cooperates with the lid to define the second channel.

4. The beverage maker of claim 3, wherein the channel member includes a hole in fluid communication with the u-shaped channel, the hole extending from a side of the channel member.

5. The beverage maker of claim 4, wherein the channel member includes a puncture member extending from the side opposite the u-shaped channel, the puncture member having a point, the puncture member being positioned to puncture the beverage container when the beverage container is placed in the holder and the lid is closed.

6. The beverage maker of claim 3, wherein the channel member further includes a wall that defines an open interior area, the open interior area cooperating with the reservoir and lid to define a fluid path that allows the user to drink liquids from the reservoir.

7. The beverage maker of claim 6, wherein the lid further includes an opening in fluid communication with the fluid path.

8. The beverage maker of claim 1, further comprising a power source coupled to the shell opposite the lid.

9. The beverage maker of claim 1, wherein the holder comprises a body portion that defines a hollow interior portion, the hollow interior portion being sized to receive the beverage cartridge, the holder further comprising one or more projections extending from a surface of the hollow interior portion, each of the one or more projections having a sharp point extending towards an open end of the hollow interior portion.

10. The beverage maker of claim 9, wherein the holder further comprises a hole positioned adjacent the one or more projections to define a fluid path from the beverage cartridge into the reservoir.

11. The beverage maker of claim 9, wherein the holder further comprises a plurality of tabs disposed about the open end of the hollow interior portion, each of the tabs being arranged to align the holder with the reservoir.

12. A method of making a beverage in a hand-held portable beverage maker, the method comprising:
placing a predetermined amount of a liquid in a reservoir;
placing a beverage cartridge in a holder and disposing the holder in the reservoir;
flowing the liquid through an opening in the bottom of the reservoir into a heater;
increasing the temperature of the liquid with the heater;
flowing the liquid with a bubble pump through a channel in the reservoir to an end opposite the bubble pump in response to increasing the temperature of the liquid;
flowing the liquid into a beverage cartridge; and
flowing the liquid from the beverage cartridge into the reservoir.

13. The method of claim 12, further comprising:
puncturing the beverage container with at least one projection disposed in the hollow interior portion of the holder; and
puncturing the beverage container with a puncture member operably coupled to a lid.

14. The method of claim 13, wherein the puncturing of the beverage container with the at least one projection and the puncture member occurs when a lid is moved from an open to a closed position.

15. The method of claim 14, further comprising latching the reservoir to the lid when the liquid is flowing into the beverage cartridge.

16. The method of claim 13, further comprising:
disposing a channel member in the lid, the lid and channel member cooperating to define a second channel fluidly coupled to the first channel; and
wherein the puncture member extends from the channel member.

17. The method of claim 16, further comprising flowing a fluid through a hole extending from the second channel to an opposite side of the channel member, the hole having an outlet adjacent the puncture member.

18. The method of claim 16, further comprising sealing a bottom surface of the channel member to the beverage cartridge.

19. The method of claim 12, further comprising aligning tabs on the holder with indentations in the reservoir before inserting the holder into the reservoir.

20. The method of claim 13, further comprising defining a port between the channel member and the lid, the port being fluidly coupled between the first channel and the second channel.
